(19) United States
(12) Patent Application Publication
(10) Pub. No.: US 2024/0061555 A1
(43) Pub. Date: Feb. 22, 2024

(54) PRESENTATION AND CONTROL OF A USER INTERFACE FOR TERRITORY OPTIMIZATION

(71) Applicant: Capital One Services, LLC, McLean, VA (US)

(72) Inventors: Renard CENAJ, San Antonio, TX (US); Buvana SIVAKUMAR, Frisco, TX (US); Pavan Kumar BELLAM, Frisco, TX (US); Sikkandar Packiam SIKKANDAR, McKinney, TX (US)

(21) Appl. No.: 17/889,666

(22) Filed: Aug. 17, 2022

(51) Int. Cl. G06F 3/0484; G06F 9/54

(52) U.S. Cl. CPC G06F 3/0484; G06F 9/542

(57) ABSTRACT

In some implementations, a device may present, on a user interface, a depiction of a map of a region, a user interface layer, over the map, that indicates a state of relationships between a plurality of entities and a plurality of territories, and information indicating one or more metrics for the plurality of territories based on the state of relationships. The device may detect a user interaction with a user interface element that indicates a new association between an entity represented by the user interface element and a territory, the new association resulting in a new state of relationships between the plurality of entities and the plurality of territories. The device may present, on the user interface, the user interface layer that indicates the new state of relationships, and the information indicating the one or more metrics for the plurality of territories based on the new state of relationships.

### BACKGROUND

A display of a user device may display a user interface (e.g., a graphical user interface). A user interface may permit interactions between a user of the user device and the user device. In some cases, the user may interact with the user interface to operate and/or control the user device to produce a desired result. For example, the user may interact with the user interface of the user device to cause the user device to perform an action. Additionally, the user interface may provide information to the user.

### SUMMARY

Some implementations described herein relate to a method of presenting a user interface for territory optimization. The method may include presenting, on a user interface of a user device, a depiction of a map of a region, a user interface layer, over the map, that indicates a state of relationships between a plurality of entities, a plurality of territories of the region, and a plurality of representatives, and information indicating one or more metrics for the plurality of territories based on the state of relationships. The user interface layer may include a plurality of first user interface elements that represent the plurality of entities and a plurality of second user interface elements that represent the plurality of representatives, the plurality of first user interface elements distributed on the map according to respective geographic locations associated with the plurality of entities. The user interface layer may include the plurality of second user interface elements distributed on the map according to respective geographic locations associated with the plurality of representatives. The user interface layer may visually differentiate the plurality of first user interface elements and the plurality of second user interface elements to indicate the state of relationships. The method may include detecting, by the user device, a user interaction with a first user interface element, of the plurality of first user interface elements, that indicates a new association between an entity, of the plurality of entities, represented by the first user interface element and a territory of the plurality of territories, the new association resulting in a new state of relationships between the plurality of entities, the plurality of territories, and the plurality of representatives. The method may include presenting, on the user interface of the user device, the user interface layer, over the map, that indicates the new state of relationships, and the information indicating the one or more metrics for the plurality of territories based on the new state of relationships.

Some implementations described herein relate to a system for controlling a user interface for territory optimization. The system may include one or more memories and one or more processors communicatively coupled to the one or more memories. The one or more processors may be configured to transmit, to a user device, first presentation information to cause the user device to present on a user interface a depiction of a map of a region, a user interface layer, over the map, that indicates a state of relationships between a plurality of entities and a plurality of territories of the region, and information indicating one or more metrics for the plurality of territories based on the state of relationships. The one or more processors may be configured to receive, from the user device, information indicating a new state of relationships between the plurality of entities and the plurality of territories that is based on a user interaction with a user interface element, of the plurality of user interface elements, that indicates a new association between an entity, of the plurality of entities, represented by the user interface element and a territory of the plurality of territories. The one or more processors may be configured to determine the one or more metrics for the plurality of territories based on the new state of relationships. The one or more processors may be configured to transmit, to the user device, second presentation information to cause the user device to present on the user interface the information indicating the one or more metrics for the plurality of territories based on the new state of relationships.

Some implementations described herein relate to a non-transitory computer-readable medium that stores a set of instructions for presenting a user interface for territory optimization for a device. The set of instructions, when executed by one or more processors of the device, may cause the device to present, on a user interface of the device, a depiction of a map of a region, a user interface layer, over the map, that indicates a state of relationships between a plurality of entities and a plurality of territories of the region, and information indicating one or more metrics for the plurality of territories based on the state of relationships. The set of instructions, when executed by one or more processors of the device, may cause the device to detect a user interaction with a user interface element, of the plurality of user interface elements, that indicates a new association between an entity, of the plurality of entities, represented by the user interface element and a territory of the plurality of territories, the new association resulting in a new state of relationships between the plurality of entities and the plurality of territories. The set of instructions, when executed by one or more processors of the device, may cause the device to present, on the user interface of the device, the user interface layer, over the map, that indicates the new state of relationships, and the information indicating the one or more metrics for the plurality of territories based on the new state of relationships.

### BRIEF DESCRIPTION OF THE DRAWINGS

FIGS. 1A-1E are diagrams of an example implementation relating to presentation and control of a user interface for territory optimization, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIGS. 4-5 are flowcharts of example processes relating to presentation and control of a user interface for territory optimization, in accordance with some embodiments of the present disclosure.

### DETAILED DESCRIPTION

The following detailed description of example implementations refers to the accompanying drawings. The same reference numbers in different drawings may identify the same or similar elements.

Territory optimization seeks to balance territories that define sales regions, or regions for similar relationship-based objectives, in a manner that provides roughly equal opportunity and proceeds across the territories. Generally, territory optimization is an iterative process in which one or more computing devices are used to generate data for a new territory alignment, transmit (e.g., by email) the data for the new territory alignment to various interested parties, and perform modifications to the data for the new territory alignment to generate new data for one or more additional new territory alignments. The one or more computing devices may process data for each new territory alignment to generate metrics or other analytics used for assessing a balance of the new territory alignment. This process may take numerous iterations over weeks or even months until an optimal territory alignment is achieved. As a result, excessive computing resources (e.g., processing resources, memory resources, and/or power resources, among other examples) are expended to perform the territory optimization.

Some implementations described herein enable a user device to present, on a user interface, a user interface layer, over a map, that provides a visual indication of a state of relationships between a plurality of entities, a plurality of territories, and/or a plurality of representatives. The user interface layer may include first user interface elements that visually represent the entities and/or second user interface elements that visually represent the representatives. The first and second user interface elements may be distributed on the map according to respective geographic locations associated with the entities and the representatives. Moreover, the user interface layer may visually differentiate the first and second user interface elements to indicate the state of relationships. In addition, the user device may present, on the user interface, information indicating one or more metrics for the territories, and the one or more metrics may be based on the state of relationships. In this way, the user interface provides user-friendly visualization of the state of relationships to facilitate fast and efficient territory optimization.

In some implementations, the user device may detect a user interaction with at least one of the first user interface elements that represents an entity, and the user interaction may indicate a new association between the entity and a territory, thereby resulting in a new state of relationships. The user device may present, on the user interface, the user interface layer, over the map, that provides a visual indication of the new state of relationships, in a similar manner as described above. Moreover, the user device may present, on the user interface, information indicating the one or more metrics for the territories, and the one or more metrics may be based on the new state of relationships. Accordingly, the updated user interface layer and the updated metrics enable fast visualization of whether the new state of relationships improved a balance of the metrics across the territories. In this way, the user interface provides user-friendly controls and editing of the state of relationships to facilitate fast and efficient territory optimization.

In some implementations, an optimization system that provides control of the user interface may analyze a new state of relationships that is indicated. For example, the optimization system may determine whether a new association between an entity and a territory is to result in excessive travel for a representative for the territory and/or whether a new association between an entity and a territory is to result in an imbalance of the metrics across the territories. As another example, the optimization system may determine one or more recommendations for changes to a new state of relationships (e.g., to improve a balance of the metrics across the territories). Prompts and/or notifications relating to the analysis of the optimization system may be provided on the user interface to further guide the territory optimization to facilitate fast and efficient territory optimization.

In this way, an optimal territory alignment (e.g., where metrics are balanced across the territories) may be achieved efficiently and with significantly fewer iterations. Accordingly, user interfaces and techniques described herein conserve computing resources, such as processing resources, memory resources, and/or power resources, among other examples, that would otherwise be expended by territory optimization that is less efficient and leads to numerous iterations.

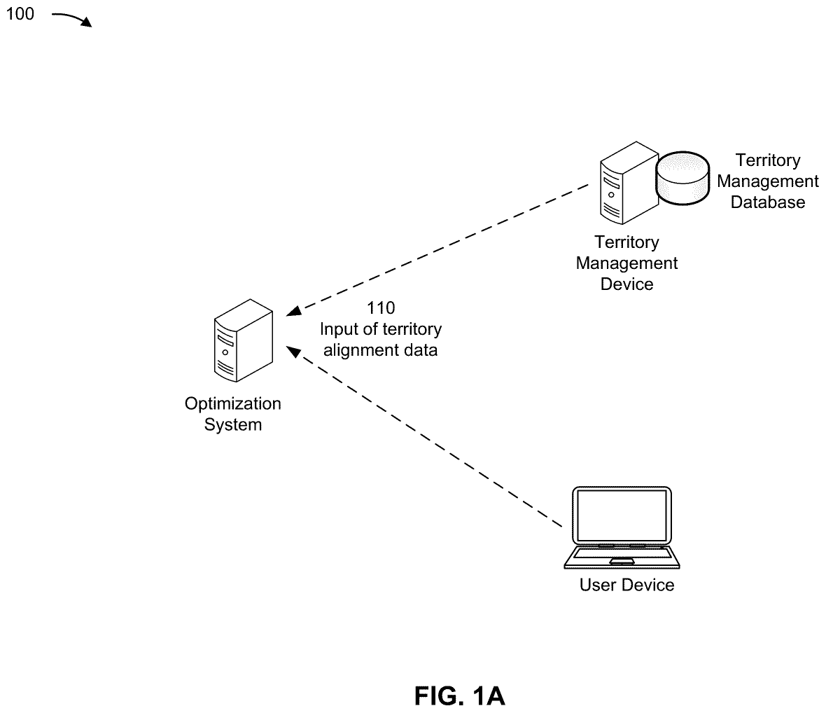

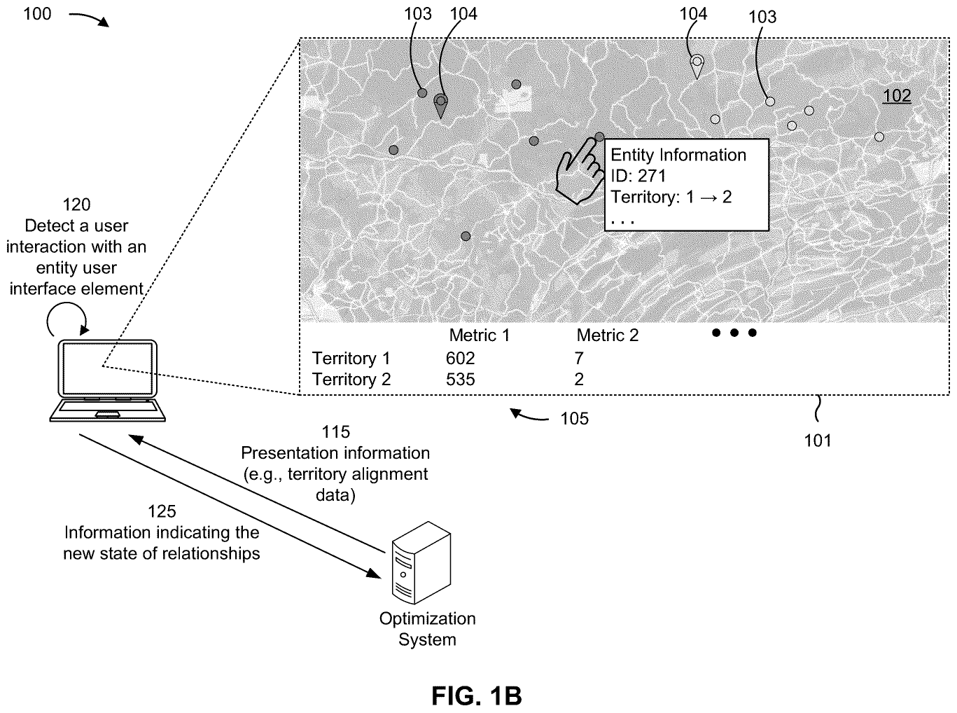

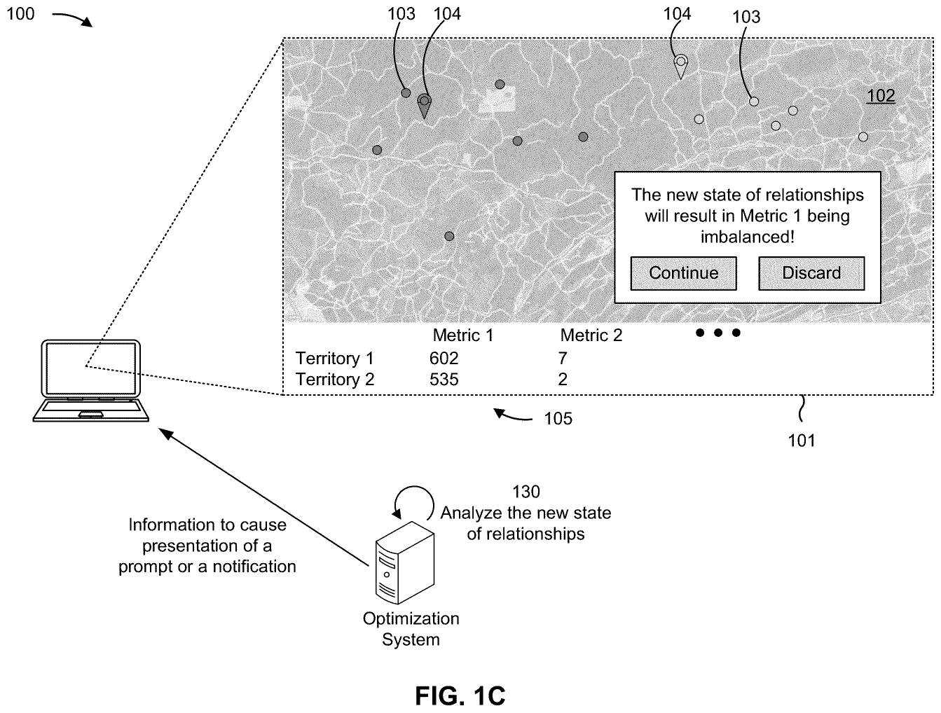

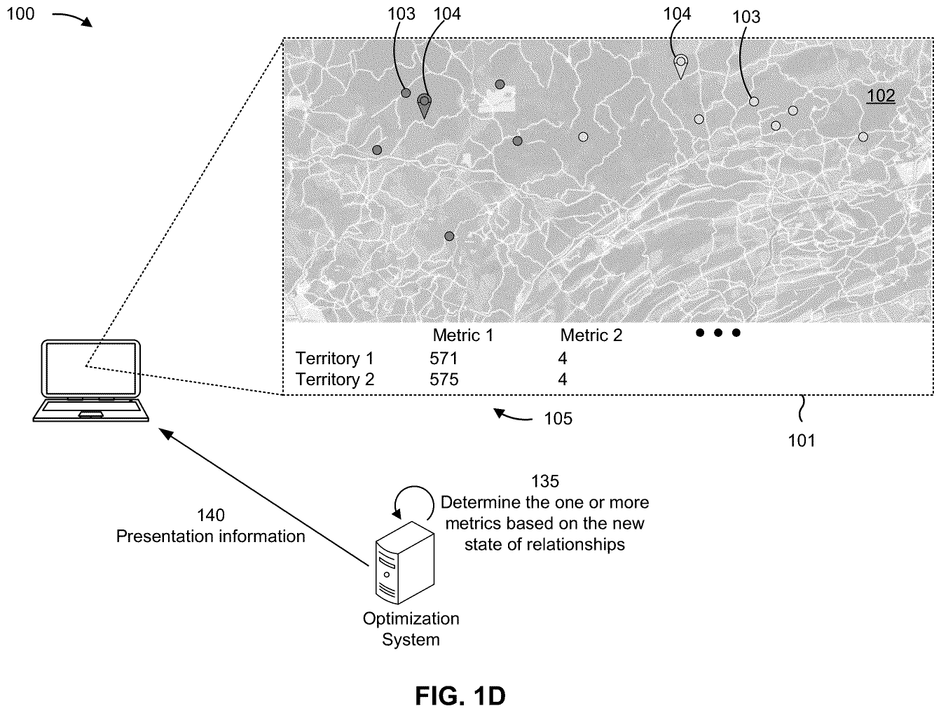

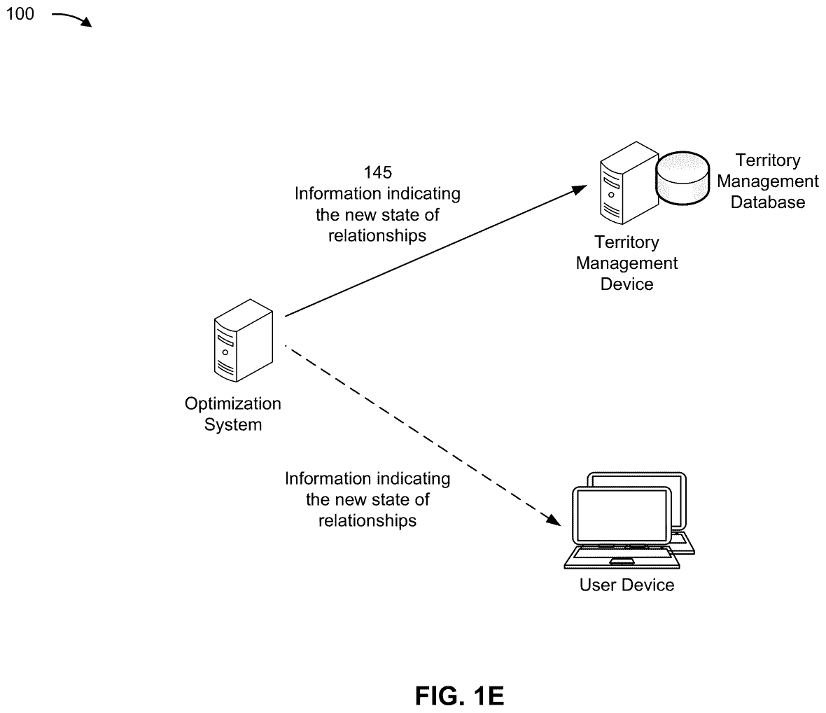

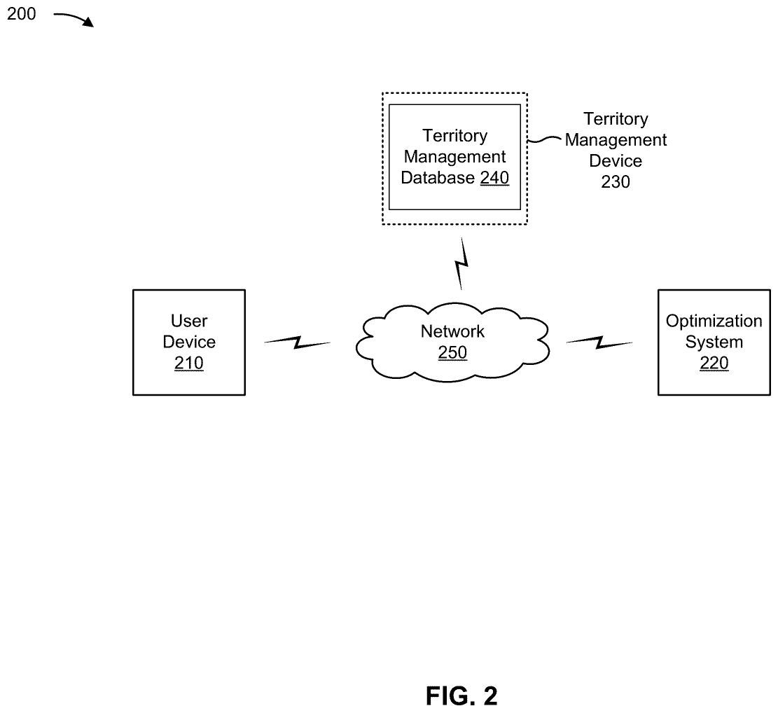

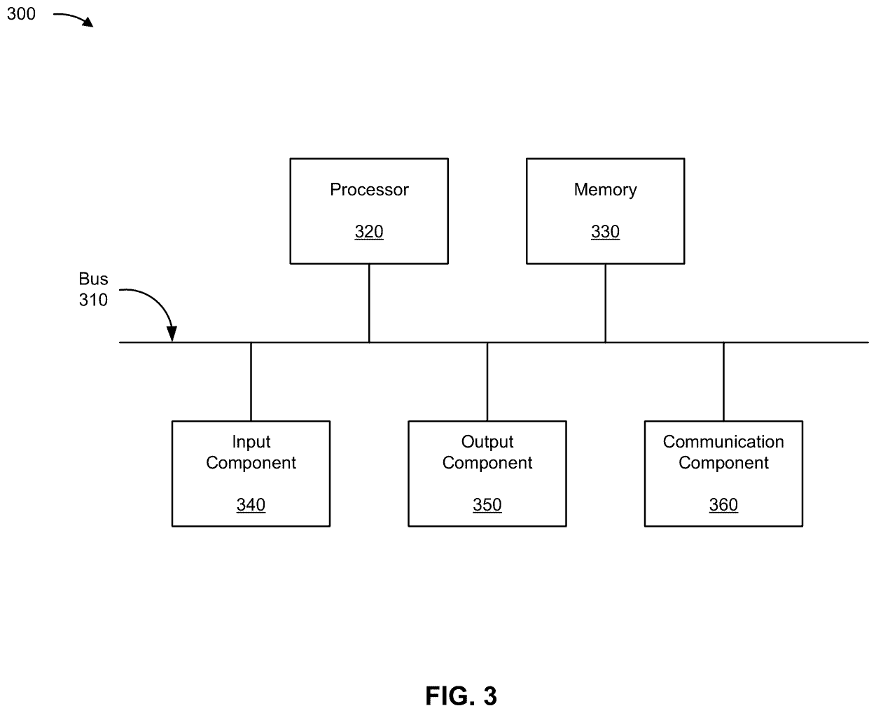

FIGS. 1A-1E are diagrams of an example 100 associated with presentation and control of a user interface for territory optimization. As shown in FIGS. 1A-1E, example 100 includes an optimization system, a user device, and a territory management device (e.g., that includes a territory management database). These devices are described in more detail in connection with FIGS. 2 and 3.

The optimization system may provide control of a user interface 101 (e.g., a graphical user interface (GUI)) that is to be presented on the user device. Likewise, the user device may be configured to present the user interface 101 (e.g., using a browser application implemented by the user device). The user interface 101 may provide visualization of a region, and territories within the region, to facilitate optimization of the territories. “Territory” may refer to a virtual area within the region that includes one or more entities (e.g., business entities, customers, or the like) that are associated with (e.g., served by, managed by, or the like) a representative (e.g., a sales manager) for the territory. For example, a territory may be defined by the entities that are associated with the territory, rather than by a geographical region that includes one or more entities (e.g., based on the entities associated with a territory, the territory may encompass a contiguous or a non-contiguous geographical region). In some implementations, an entity may be a car dealership. In some implementations, the representatives may represent an organization that provides financing to customers of the car dealership to facilitate transactions. Thus, the representatives may seek to establish relationships with the car dealerships in connection with the financing provided by the organization. Optimization of the territories may include aligning or re-aligning various entities with various territories to balance one or more metrics across the territories. The one or more metrics may be balanced if the one or more metrics for each territory are within a threshold amount, a threshold percentage, or the like, of each other.

As shown in FIG. 1A, and by reference number 110, the optimization system may receive an input of territory alignment data. The territory alignment data may indicate a state of relationships between a plurality of entities, a plurality of territories of a region, and/or a plurality of representatives. For example, the territory alignment data may indicate that a first territory is associated with a first set of entities and a first representative, a second territory is associated with a second set of entities and a second representative, and so forth. In some implementations, the optimization system may receive the input of the territory alignment data from the user device or from the territory management device.

In some implementations, the territory alignment data may be generated by an analyst. In some implementations, the territory alignment data may be an output of a machine learning model trained for territory optimization (e.g., the state of relationships may be based on the output of the machine learning model). In some implementations, the territory alignment data may be the result of a previous territory optimization that is performed through the user interface 101 described herein. In some cases, the state of relationships indicated by the territory alignment data may be sub-optimal or otherwise unsuitable or undesirable.

As shown in FIG. 1B, and by reference number 115, the optimization system may transmit, and the user device may receive, presentation information that is to cause the user device to present, on a user interface 101 of the user device, a depiction of a map 102 of the region and a user interface layer over (e.g., overlaid on) the map 102. In some implementations, the presentation information may indicate the territory alignment data. The user device may present, on the user interface 101, the depiction of the map 102 of the region and the user interface layer over the map 102 (e.g., based on receiving the presentation information). In some implementations, the user interface layer may indicate the state of relationships between the entities, the territories, and the representatives. In some implementations, the user interface layer may indicate the state of relationships between the entities and the territories.

The user interface layer may include a plurality of first user interface elements 103 that represent the entities (which may be referred to herein as “entity user interface elements”). The entity user interface elements 103 may be distributed on the map 102 according to respective geographic locations associated with the entities. The entity user interface elements 103 may include dot icons, pin icons, or the like. Additionally, or alternatively, the user interface layer may include a plurality of second user interface elements 104 that represent the representatives (which may be referred to herein as “representative user interface elements”). The representative user interface elements 104 may be distributed on the map according to respective geographic locations (e.g., residence locations or office locations) associated with the representatives. The representative user interface elements 104 may also include dot icons, pin icons, or the like. However, the representative user interface elements 104 may be visually distinguishable from the entity user interface elements 103 (e.g., the entity user interface elements 103 may be dot icons and the representative user interface elements 104 may be pin icons). Inclusion of the entity user interface elements 103 and the representative user interface elements 104 together in the user interface layer may facilitate visualization of distances between entities and representatives to facilitate territory optimization with improved accuracy and speed.

In addition, the user interface layer may visually differentiate the entity user interface elements 103 and/or the representative user interface elements 104 to indicate the state of relationships. For example, the user interface layer may visually differentiate the entity user interface elements 103 and/or the representative user interface elements 104 using a respective color for each of the territories (e.g., different colors for each of the territories or different colors at least for adjacent territories). As an example, the entity user interface elements 103 and/or the representative user interface elements 104 associated with a first territory may be a first color, the entity user interface elements 103 and/or the representative user interface elements 104 associated with a second territory may be a second color, and so forth. In this way, the user interface layer facilitates visualization of the state of relationships between the entities, the territories, and/or the representatives.

The presentation information may also indicate one or more metrics for the territories based on the state of relationships. Accordingly, the optimization system may transmit the presentation information to also cause the user device to present, on the user interface 101, information 105 indicating the one or more metrics for the territories. The user device may present, on the user interface 101, the information 105 indicating the one or more metrics for the territories (e.g., based on receiving the presentation information). The information may indicate the one or more metrics on a per-territory basis. For example, if the metrics include a first metric and a second metric, the information may indicate first values for the first metric and the second metric for a first territory, second values for the first metric and the second metric for a second territory, and so forth. In some implementations, the information may also indicate the one or more metrics for the territories aggregated at a hierarchical level above the territories. For example, the hierarchical level above the territories may include a plurality of areas (e.g., states, countries, etc.) that each include one or more territories.

In some implementations, a metric for a territory may include an aggregate historical income (or profit) attributable to entities associated with the territory. The aggregate historical income (or profit) may include total historical incomes (or profits) associated with each of the entities, total historical incomes (or profits) over a particular time period (e.g., a week, a month, a year, or the like) associated with each of the entities, average historical incomes (or profits) associated with each of the entities (e.g., on a weekly basis, a monthly basis, a yearly basis, or the like). Additionally, or alternatively, a metric for the territory may include an estimated aggregate future income (or profit) attributable to entities associated with the territory (e.g., in a future week, a future month, a future year, or in total). Additionally, or alternatively, a metric for the territory may include an average distance (or a total distance) of geographic locations of the entities associated with the territory from a geographic location of a representative associated with the territory. Additionally, or alternatively, a metric for the territory may include a proportion (e.g., a percentage) of the entities associated with the territory that are associated with a particular relationship quality level. For example, an entity may be associated with the particular relationship quality level (e.g., a top-tier relationship quality) based on one or more relationship indicators of the entity exceeding a threshold (e.g., a total income/profit attributable to the entity exceeding a threshold, an average income/profit attributable to the entity exceeding a threshold, or the like). Additionally, or alternatively, a metric for the territory may include a total quantity of units (e.g., cars) in inventories of the entities (e.g., car dealerships) associated with the territory. Additionally, or alternatively, a metric for the territory may include a quantity of entities associated with the territory.

As shown by reference number 120, the user device may detect a user interaction with an entity user interface element 103 representing an entity. In some implementations, responsive to a user interaction with the entity user interface element 103, the user device may present, on the user interface 101, an information element (e.g., a pop-up user interface element) that indicates entity information associated with the entity. The entity information may indicate a name of the entity, an address of the entity, a relationship quality level associated with the entity, an identifier associated with the entity (e.g., a numeric identifier or an alphanumeric identifier), a territory with which the entity is associated, and/or a representative associated with the territory, among other examples. In some implementations, the information element may also include a field for input by a user that enables re-association of the entity with a different territory.

The user interaction with the entity user interface element 103 may indicate a new association between the entity and a different territory. For example, the user interaction may include an input to the field to re-associate the entity and the different territory. As another example, to indicate the new association between the entity and the different territory, the user interaction may include clicking or tapping, in succession, the entity user interface element 103 associated with the entity and a representative user interface element 104 representing a representative associated with the different territory. As a further example, to indicate the new association between the entity and the different territory, the user interaction may include dragging the entity user interface element 103 to the representative user interface element 104 or dragging the representative user interface element 104 to the entity user interface element 103 (e.g., where after the new association is made, the entity user interface element 103 or the representative user interface element 104 returns to an original position). In some implementations, the user interaction may select multiple entities (e.g., associated with the same territory or with different territories) to indicate the new association between the multiple entities and the different territory. In this way, the entity user interface elements 103 may facilitate moving entities between territories, thereby defining new territories based on the entities that are associated with the territories (e.g., a territory is defined by the entities within the territories, rather than by a geographical region). Accordingly, the entity user interface elements 103 may facilitate fast territory re-alignment, thereby conserving computing resources that otherwise may be expended if the entity user interface elements 103 were not used.

The new association of the entity may result in a new state of relationships between the entities, the territories, and/or the representatives. For example, according to the initial state of relationships the entity may be associated with a first territory that is associated with a first representative, and according to the new state of relationships the entity may be associated with a second territory that is associated with a second representative. The new state of relationships may include a single re-association of an entity (e.g., based on a single user interaction) or may include multiple re-associations of entities (e.g., based on multiple user interactions). In some implementations, the user device may be the only user device at a given time that is permitted to present and/or allow interaction with the user interface 101 (e.g., a single user update mode). In some implementations, multiple user devices my concurrently present and allow interaction with the user interface 101 (e.g., a multi-user update mode).

In some implementations, the user device may detect a user interaction with a representative user interface element 104 representing a representative. In some implementations, responsive to a user interaction with the representative user interface element 104, the user device may present, on the user interface 101, an information element (e.g., a pop-up user interface element) that indicates representative information associated with the representative. The representative information may indicate a name of the representative, an address of the representative, an identifier associated with the representative (e.g., a numeric identifier or an alphanumeric identifier), and/or a territory with which the representative is associated, among other examples. In some implementations, the information element may also include a field for input by a user that enables re-association of the representative with a different territory. The user interaction with the representative user interface element 104 may indicate a new association between the representative and a different territory, in a similar manner as described above for re-association of an entity.

As shown by reference number 125, the user device may transmit, and the optimization system may receive, information indicating the new state of relationships (e.g., updated territory alignment data). For example, the information may indicate the new association between the entity and the different territory.

As shown in FIG. 1C, and by reference number 130, the optimization system may analyze the new state of relationships. In some implementations, the optimization system may determine that the new state of relationships includes an association between an entity and a territory associated with a representative that is associated with a geographic location that is more than a threshold distance (e.g., a threshold driving distance) from a geographic location associated with the entity (in other words, the entity is located too far away from the representative for the territory). Here, the optimization system may transmit, to the user device, information to cause the user device to present, on the user interface 101, a prompt to indicate whether the new state of relationships is to be used or discarded. That is, the user device may present, on the user interface 101, the prompt if the new state of relationships includes an association between an entity and a territory associated with a representative that is associated with a geographic location that is more than a threshold distance from a geographic location associated with the entity (e.g., based on receiving the information from the optimization system).

In some implementations, the optimization system may determine that the new state of relationships is to result in at least one metric being imbalanced across the territories (e.g., the metrics for each of the territories are not within a threshold amount or a threshold percentage of each other). Here, the optimization system may transmit, to the user device, information to cause the user device to present, on the user interface 101, a prompt to indicate whether the new state of relationships is to be used or discarded. That is, the user device may present, on the user interface 101, the prompt if the new state of relationships is to result in at least one metric being imbalanced across the territories (e.g., based on receiving the information from the optimization system).

In some implementations, the optimization system may determine, based on the new state of relationships, one or more recommendations for changes to the new state of relationships. For example, a change may be to re-associate an entity with a different territory or to re-associate a representative with a different territory. The optimization system may determine the one or more recommendations for the changes to remedy an imbalance of at least one metric across the territories, to improve a balance of at least one metric across the territories, or the like. In some implementations, the optimization system may use a machine learning model trained for territory optimization (such as the machine learning model described above) to determine the one or more recommendations for the changes. The optimization system may transmit, to the user device, information to cause the user device to present, on the user interface 101, a notification indicating the one or more recommendations. Moreover, the user device may present, on the user interface 101, the notification (e.g., based on receiving the information from the optimization system). In some implementations, the notification may include an input element that enables automatic execution of the changes of the one or more recommendations.

As shown in FIG. 1D, and by reference number 135, the optimization system may determine the one or more metrics for the territories (e.g., determine at least one metric on a per-territory basis) based on the new state of relationships. For example, the optimization system may determine the one or more metrics based on receiving an indication from the user device, responsive to a prompt as described above, indicating that the new state of relationships is to be used (or is not to be discarded).

As shown by reference number 140, the optimization system may transmit, and the user device may receive, presentation information to cause the user device to present (e.g., in real time), on the user interface 101, information indicating the one or more metrics for the plurality of territories based on the new state of relationships. Accordingly, the user device may present, on the user interface 101, the information indicating the one or more metrics for the plurality of territories based on the new state of relationships. Moreover, the user device may present (e.g., in real time), on the user interface 101, the user interface layer, over the map 102, that indicates the new state of relationships. For example, the user interface layer may visually differentiate the entity user interface elements 103 and/or the representative user interface elements 104 to indicate the new state of relationships, in a similar manner as described above. In some implementations, the user device may present the user interface layer that indicates the new state of relationships based on an indication, responsive to a prompt as described above, that the new state of relationships is to be used (or is not to be discarded).

In some implementations, the user interface 101 may include an input element to enable information relating to the new state of relationships (e.g., updated territory alignment data) to be exported for, or transmitted to, one or more other user devices (e.g., in a single-user mode). In some implementations, the user interface 101 may include an input element to enable locking of the new state of relationships (e.g., in a multi-user mode). In some implementations, the optimization system may receive, for the representatives (e.g., from respective user devices of the representatives), indications of approval of the new state of relationships. For example, the optimization system may receive the indications of approval after the information relating to the new state of relationships has been exported for, or transmitted to, the one or more other user devices and/or after the new state of relationships has been locked.

In some implementations, the user interface 101 may include one or more input elements to enable importing data or exporting data. In some implementations, the user interface 101 may include one or more input elements to enable undoing of previous actions. In some implementations, the user interface 101 may include one or more input elements to enable the addition of new territories, new entities, new representatives, or the like.

As shown in FIG. 1E, and by reference number 145, the optimization system may transmit, to the relationship management device, information indicating the new state of relationships (e.g., updated territory alignment data). The relationship management device may include a relationship management database that stores the territory alignment data. In some implementations, the optimization system may transmit information indicating the new state of relationships to one or more user devices (e.g., user devices associated with the representatives). For example, the optimization may transmit, to a user device associated with a representative, information indicating the new state of relationships with respect to a territory associated with the representative. The information may further indicate the one or more metrics associated with the territory. Moreover, the information may indicate driving directions from a geographic location associated with the representative to respective geographic locations associated with the entities associated with the territory and/or an optimal order in which the representative should visit the entities (e.g., optimal for travel efficiency and/or optimal for generating income, among other examples).

In this way, an optimal territory alignment (e.g., where metrics are balanced across the territories) may be achieved efficiently and with significantly fewer iterations. Accordingly, user interfaces and techniques described herein conserve computing resources, such as processing resources, memory resources, and/or power resources, among other examples, that would otherwise be expended by territory optimization that is less efficient and leads to numerous iterations.

As indicated above, FIGS. 1A-1E are provided as an example. Other examples may differ from what is described with regard to FIGS. 1A-1E.

FIG. 2 is a diagram of an example environment 200 in which systems and/or methods described herein may be implemented. As shown in FIG. 2, environment 200 may include a user device 210, an optimization system 220, a territory management device 230 (e.g., that includes a territory management database 240), and a network 250. Devices of environment 200 may interconnect via wired connections, wireless connections, or a combination of wired and wireless connections.

The user device 210 includes one or more devices capable of receiving, generating, storing, processing, and/or providing information associated with presentation and control of a user interface for territory optimization, as described elsewhere herein. The user device 210 may include a communication device and/or a computing device. For example, the user device 210 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The optimization system 220 includes one or more devices capable of receiving, generating, storing, processing, providing, and/or routing information associated with presentation and control of a user interface for territory optimization, as described elsewhere herein. The optimization system 220 may include a communication device and/or a computing device. For example, the optimization system 220 may include a server, such as an application server, a client server, a web server, a database server, a host server, a proxy server, a virtual server (e.g., executing on computing hardware), or a server in a cloud computing system. In some implementations, the optimization system 220 includes computing hardware used in a cloud computing environment.

The territory management device 230 includes one or more devices capable of receiving, generating, storing, processing, providing, and/or routing information associated with presentation and control of a user interface for territory optimization, as described elsewhere herein. The territory management device 230 may include a communication device and/or a computing device. For example, the territory management device 230 may include a server, such as an application server, a client server, a web server, a database server, a host server, a proxy server, a virtual server (e.g., executing on computing hardware), or a server in a cloud computing system. In some implementations, the territory management device 230 includes computing hardware used in a cloud computing environment.

The territory management database 240 includes one or more devices capable of receiving, generating, storing, processing, and/or providing information associated with presentation and control of a user interface for territory optimization, as described elsewhere herein. The territory management database 240 may include a communication device and/or a computing device. For example, the territory management database 240 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the territory management database 240 may store territory alignment data, as described elsewhere herein.

The network 250 includes one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to user device 210, optimization system 220, territory management device 230, and/or territory management database 240. In some implementations, user device 210, optimization system 220, territory management device 230, and/or territory management database 240 include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

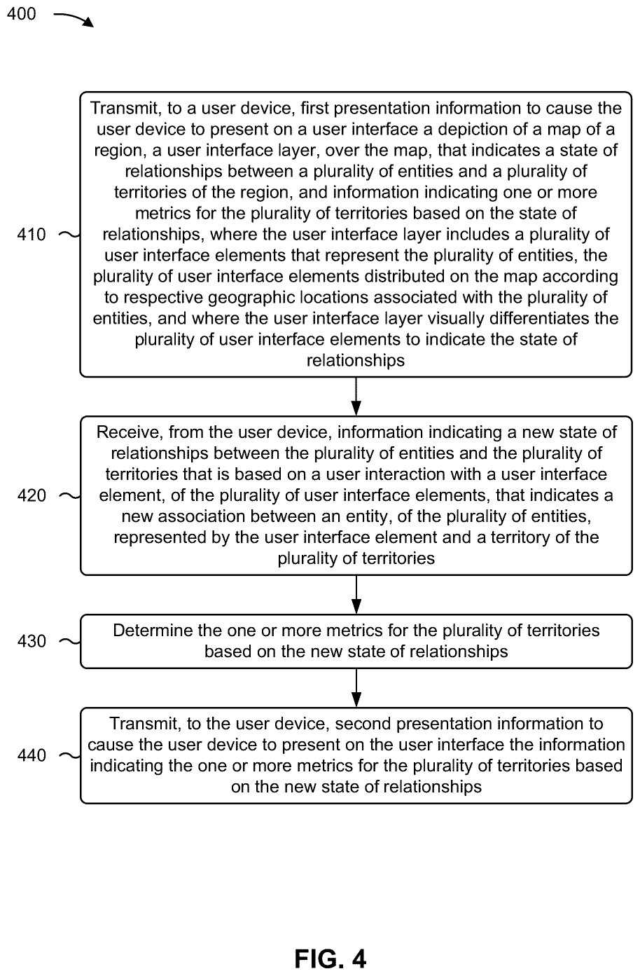

FIG. 4 is a flowchart of an example process 400 associated with presentation and control of a user interface for territory optimization. In some implementations, one or more process blocks of FIG. 4 may be performed by the optimization system 220. In some implementations, one or more process blocks of FIG. 4 may be performed by another device or a group of devices separate from or including the optimization system 220, such as the user device 210 and/or the territory management device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include transmitting, to a user device, first presentation information to cause the user device to present on a user interface a depiction of a map of a region, a user interface layer, over the map, that indicates a state of relationships between a plurality of entities and a plurality of territories of the region, and information indicating one or more metrics for the plurality of territories based on the state of relationships, where the user interface layer includes a plurality of user interface elements that represent the plurality of entities, the plurality of user interface elements distributed on the map according to respective geographic locations associated with the plurality of entities, and where the user interface layer visually differentiates the plurality of user interface elements to indicate the state of relationships (block 410).

For example, the optimization system 220 (e.g., using processor 320, memory 330, and/or communication component 360) may transmit, to a user device, first presentation information to cause the user device to present on a user interface a depiction of a map of a region, a user interface layer, over the map, that indicates a state of relationships between a plurality of entities and a plurality of territories of the region, and information indicating one or more metrics for the plurality of territories based on the state of relationships, as described above in connection with reference number 115 of FIG. 1B. As an example, the first presentation information may cause the user device to present the user interface, and the user interface may include the map with the user interface layer, overlaid on the map, that shows associations between entities and territories in a visual manner (e.g., by using a respective color for each territory). In some implementations, the user interface layer includes a plurality of user interface elements that represent the plurality of entities, the plurality of user interface elements distributed on the map according to respective geographic locations associated with the plurality of entities. In some implementations, the user interface layer visually differentiates the plurality of user interface elements to indicate the state of relationships.

As further shown in FIG. 4, process 400 may include receiving, from the user device, information indicating a new state of relationships between the plurality of entities and the plurality of territories that is based on a user interaction with a user interface element, of the plurality of user interface elements, that indicates a new association between an entity, of the plurality of entities, represented by the user interface element and a territory of the plurality of territories (block 420). For example, the optimization system 220 (e.g., using processor 320, memory 330, input component 340, and/or communication component 360) may receive, from the user device, information indicating a new state of relationships between the plurality of entities and the plurality of territories that is based on a user interaction with a user interface element, of the plurality of user interface elements, that indicates a new association between an entity, of the plurality of entities, represented by the user interface element and a territory of the plurality of territories, as described above in connection with reference number 125 of FIG. 1B. As an example, the user interface element may be configured to trigger presentation on the user interface of an information element, that includes a field for input, and the information indicating the new state of relationships may be based on an input to the field that indicates a re-association of the entity with the territory.

As further shown in FIG. 4, process 400 may include determining the one or more metrics for the plurality of territories based on the new state of relationships (block 430). For example, the optimization system 220 (e.g., using processor 320 and/or memory 330) may determine the one or more metrics for the plurality of territories based on the new state of relationships, as described above in connection with reference number 135 of FIG. 1D. As an example, the re-association of the entity with the territory may change one or more metrics for the plurality of territories.

As further shown in FIG. 4, process 400 may include transmitting, to the user device, second presentation information to cause the user device to present on the user interface the information indicating the one or more metrics for the plurality of territories based on the new state of relationships (block 440). For example, the optimization system 220 (e.g., using processor 320, memory 330, and/or communication component 360) may transmit, to the user device, second presentation information to cause the user device to present on the user interface the information indicating the one or more metrics for the plurality of territories based on the new state of relationships, as described above in connection with reference number 140 of FIG. 1D. As an example, the second presentation information may cause the user device to present, on the user interface, updated metrics based on the re-association of the entity with the territory.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1E. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

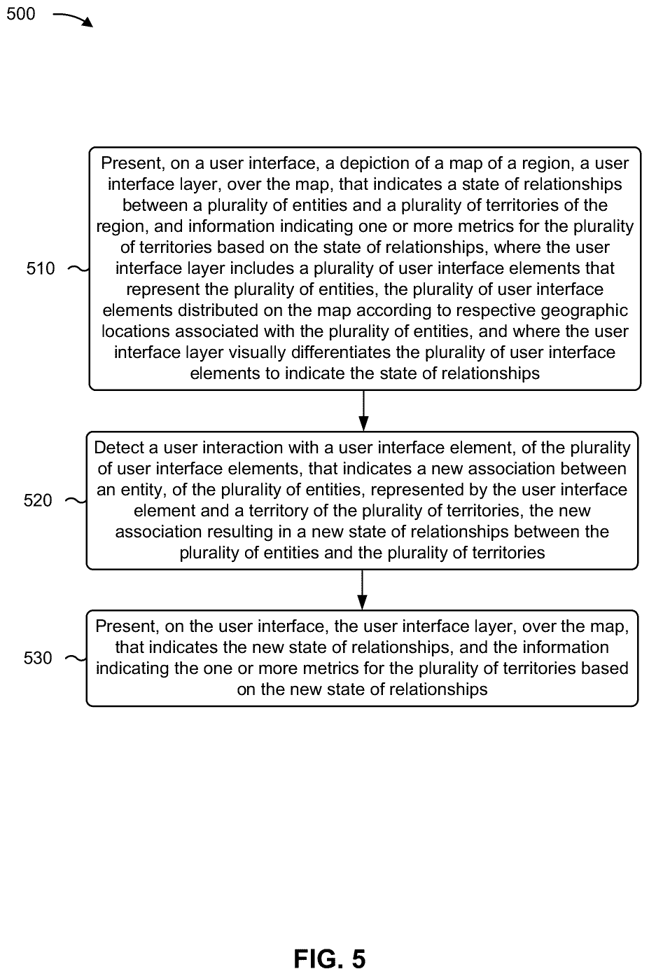

FIG. 5 is a flowchart of an example process 500 associated with presentation and control of a user interface for territory optimization. In some implementations, one or more process blocks of FIG. 5 may be performed by the user device 210. In some implementations, one or more process blocks of FIG. 5 may be performed by another device or a group of devices separate from or including the user device 210, such as the optimization system 220 and/or the territory management device 230. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include presenting, on a user interface, a depiction of a map of a region, a user interface layer, over the map, that indicates a state of relationships between a plurality of entities and a plurality of territories of the region, and information indicating one or more metrics for the plurality of territories based on the state of relationships, where the user interface layer includes a plurality of user interface elements that represent the plurality of entities, the plurality of user interface elements distributed on the map according to respective geographic locations associated with the plurality of entities, and where the user interface layer visually differentiates the plurality of user interface elements to indicate the state of relationships (block 510).

For example, the user device 210 (e.g., using processor 320, memory 330, and/or output component 350) may present, on a user interface, a depiction of a map of a region, a user interface layer, over the map, that indicates a state of relationships between a plurality of entities and a plurality of territories of the region, and information indicating one or more metrics for the plurality of territories based on the state of relationships, as described above in connection with reference number 115 of FIG. 1B. As an example, the user interface may include the map with the user interface layer, overlaid on the map, that shows associations between entities and territories in a visual manner (e.g., by using a respective color for each territory). In some implementations, the user interface layer includes a plurality of user interface elements that represent the plurality of entities, the plurality of user interface elements distributed on the map according to respective geographic locations associated with the plurality of entities. In some implementations, the user interface layer visually differentiates the plurality of user interface elements to indicate the state of relationships.

As further shown in FIG. 5, process 500 may include detecting a user interaction with a user interface element, of the plurality of user interface elements, that indicates a new association between an entity, of the plurality of entities, represented by the user interface element and a territory of the plurality of territories, the new association resulting in a new state of relationships between the plurality of entities and the plurality of territories (block 520). For example, the user device 210 (e.g., using processor 320, memory 330, and/or input component 340) may detect a user interaction with a user interface element, of the plurality of user interface elements, that indicates a new association between an entity, of the plurality of entities, represented by the user interface element and a territory of the plurality of territories, the new association resulting in a new state of relationships between the plurality of entities and the plurality of territories, as described above in connection with reference number 120 of FIG. 1B. As an example, the user interface element may be configured to trigger presentation on the user interface of an information element, that includes a field for input, and the new state of relationships may be based on an input to the field that indicates a re-association of the entity with the territory.

As further shown in FIG. 5, process 500 may include presenting, on the user interface, the user interface layer, over the map, that indicates the new state of relationships, and the information indicating the one or more metrics for the plurality of territories based on the new state of relationships (block 530). For example, the user device 210 (e.g., using processor 320, memory 330, and/or output component 350) may present, on the user interface, the user interface layer, over the map, that indicates the new state of relationships, and the information indicating the one or more metrics for the plurality of territories based on the new state of relationships, as described above in connection with reference number 140 of FIG. 1D. As an example, the user interface, including the user interface elements and the metrics, may be updated based on the re-association of the entity with the territory.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of territory optimization, comprising:
presenting, on a user interface of a user device, a user interface layer over a map of a region,
wherein the user interface layer indicates:
a state of relationships between a plurality of entities, a plurality of territories of the region, and a plurality of representatives, and
information indicating one or more metrics for the plurality of territories based on the state of relationships,
wherein the user interface layer includes:
a plurality of first user interface elements that represent the plurality of entities,
wherein the plurality of first user interface elements are distributed on the map according to respective geographic locations associated with the plurality of entities, and
a plurality of second user interface elements that represent the plurality of representatives,
wherein the plurality of second user interface elements are distributed on the map according to respective geographic locations associated with the plurality of representatives, and
wherein the user interface layer visually differentiates the plurality of first user interface elements and the plurality of second user interface elements to indicate the state of relationships;
detecting, by the user device, a user interaction with a first user interface element, of the plurality of first user interface elements, that indicates a new association between an entity, of the plurality of entities, a representative, of the plurality of representatives, and a territory, of the plurality of territories,
wherein the new association results in a new state of relationships between the plurality of entities, the plurality of territories, and the plurality of representatives;
presenting, on the user interface of the user device and based on a determination that a distance between a geographic location associated with the entity and a geographic location associated with the representative is more than a threshold distance, a prompt to indicate whether the new state of relationships is to be used or discarded;
transmitting, by the user device, based on a determination that an income attributable to the entity is greater than an income threshold, and in response to the prompt, an indication that the new state of relationships is to be used; and
presenting, on the user interface of the user device and based on the indication, an updated user interface layer over the map,
wherein the updated user interface layer indicates:
the new state of relationships, and
updated information indicating the one or more metrics for the plurality of territories based on the new state of relationships.

2. The method of claim 1, wherein the one or more metrics, for a territory of the plurality of territories, include one or more of:
an aggregate historical income attributable to entities, of the plurality of entities, associated with the territory,
an estimated aggregate future income attributable to the entities,
an average distance of geographic locations of the entities from a geographic location of a representative, of the plurality of representatives, associated with the territory,
a proportion of the entities that are associated with a particular relationship quality level,
a total quantity of units in inventories of the entities, or
a quantity of the entities.

3. The method of claim 1, wherein the state of relationships is based on an output of a machine learning model trained for territory optimization.

4. (canceled)

5. The method of claim 1,
wherein the prompt indicates that the new state of relationships, if used, is to result in at least one metric, of the one or more metrics, being imbalanced across the plurality of territories.

6. The method of claim 1, further comprising:
presenting, on the user interface of the user device, another notification indicating one or more recommendations for changes to the new state of relationships that are based on the new state of relationships.

7. The method of claim 1, further comprising:
transmitting, to a device, information indicating the new state of relationships; and
receiving, from the device, the information indicating the one or more metrics for the plurality of territories based on the new state of relationships.

8. The method of claim 1, further comprising:
presenting, on the user interface of the user device, an information element that indicates entity information associated with an entity, of the plurality of entities, responsive to the user interaction with the first user interface element.

9. A system for controlling a user interface for territory optimization, the system comprising:
one or more memories; and
one or more processors, communicatively coupled to the one or more memories, configured to:
transmit, to a user device, first presentation information to cause the user device to present, on a user interface, a user interface layer over a map of a region,
wherein the user interface layer indicates:
a state of relationships between a plurality of entities, a plurality of territories of the region, and a plurality of representatives, and
information indicating one or more metrics for the plurality of territories based on the state of relationships, and
wherein the user interface layer is to include a plurality of user interface elements that represent the plurality of entities and the plurality of representatives,
wherein the plurality of user interface elements are to be distributed on the map according to respective geographic locations associated with the plurality of entities and the plurality of representatives, and
wherein the user interface layer is to visually differentiate the plurality of user interface elements to indicate the state of relationships;
receive, from the user device, information indicating a new state of relationships between the plurality of entities, the plurality of territories, and the plurality of representatives that is based on a user interaction with a user interface element, of the plurality of user interface elements,
wherein the user interaction indicates a new association between an entity, of the plurality of entities, a territory, of the plurality of territories, and a representative, of the plurality of representatives;
determine, based on the new state of relationships, that a distance between a geographic location associated with the entity and a geographic location associated with the representative is more than a threshold distance;
transmit, to the user device and based on the distance being more than the threshold distance, information to cause the user device to present on the user interface a prompt to indicate whether the new state of relationships is to be used or discarded;
receive, from the user device and a based on a determination that an income attributable to the entity is greater than an income threshold, an indication that the new state of relationships is to be used;
determine, based on the indication, the one or more metrics for the plurality of territories based on the new state of relationships; and
transmit, to the user device, second presentation information to cause the user device to present on the user interface the information indicating the one or more metrics for the plurality of territories based on the new state of relationships.

10. The system of claim 9, wherein the one or more processors are further configured to:
transmit, to a relationship management device, information indicating the new state of relationships.

11. (canceled)

12. The system of claim 9, wherein the user device is associated with the representative,
wherein the representative is associated with the territory, and
wherein the one or more processors are further configured to:
transmit, to the user device, information indicating at least one of:
the new state of relationships with respect to the territory,
or
driving directions from the geographic location associated with the representative to respective geographic locations associated with entities associated with the territory.

13. The system of claim 9,
wherein the plurality of user interface elements include a plurality of first user interface elements and a plurality of second user interface elements,
wherein the plurality of first user interface elements include a first type of icon and represent the plurality of entities, and
wherein the plurality of second user interface elements include a second type of icon and represent the plurality of representatives.

14. (canceled)

15. The system of claim 9, wherein the
prompt is to indicate that the new state of relationships, if used, is to result in at least one metric, of the one or more metrics, being imbalanced across the plurality of territories.

16. The system of claim 9, wherein the one or more processors are further configured to:
determine, based on the new state of relationships, one or more recommendations for changes to the new state of relationships; and
transmit, to the user device, information to cause the user device to present on the user interface a notification indicating the one or more recommendations.

17. A non-transitory computer-readable medium storing a set of instructions for territory optimization, the set of instructions comprising:
one or more instructions that, when executed by one or more processors of a device, cause the device to:
present, on a user interface of the device, a user interface layer over a map of a region,
wherein the user interface layer indicates:
a state of relationships between a plurality of entities, a plurality of territories of the region, and a plurality of representatives, and
information indicating one or more metrics for the plurality of territories based on the state of relationships, and
wherein the user interface layer includes a plurality of user interface elements that represent the plurality of entities and the plurality of representatives,
wherein the plurality of user interface elements are distributed on the map according to respective geographic locations associated with the plurality of entities and the plurality of representatives, and
wherein the user interface layer visually differentiates the plurality of user interface elements to indicate the state of relationships;
detect a user interaction with a user interface element, of the plurality of user interface elements, that indicates a new association between an entity, of the plurality of entities, a territory, of the plurality of territories, and a representative, of the plurality of representatives,
wherein the new association results in a new state of relationships between the plurality of entities, the plurality of territories, and the plurality of representatives;
present, on the user interface and based on a determination that a distance between a geographic location associated with the entity and a geographic location associated with the representative is more than a threshold distance, a prompt to indicate whether the new state of relationships is to be used or discarded;
transmit, based on a determination that an income attributable to the entity is greater than an income threshold and in response to the prompt, an indication that the new state of relationships is to be used; and
present, on the user interface of the device and based on the indication, an updated user interface layer over the map,
wherein the updated user interface layer indicates:
the new state of relationships, and
updated information indicating the one or more metrics for the plurality of territories based on the new state of relationships.

18. The non-transitory computer-readable medium of claim 17,
wherein the plurality of user interface elements includes a plurality of first user interface elements that include a first type of icon and represent the plurality of entities, and
wherein the plurality of user interface elements further include a plurality of second user interface elements that include a second type of icon and represent the plurality of representatives.

19. The non-transitory computer-readable medium of claim 17, wherein the one or more metrics, for a territory of the plurality of territories, include one or more of:
an aggregate historical income attributable to entities, of the plurality of entities, associated with the territory,
an estimated aggregate future income attributable to the entities,
an average distance of geographic locations of the entities from a geographic location of a representative, of the plurality of representatives, associated with the territory,
a proportion of the entities that are associated with a particular relationship quality level,
a total quantity of units in inventories of the entities, or
a quantity of the entities.

20. The non-transitory computer-readable medium of claim 17, wherein the user interface layer visually differentiates the plurality of user interface elements using a respective color for each territory of the plurality of territories.

21. The method of claim 1, wherein the territory encompasses a non-continuous geographical region.

22. The system of claim 9, wherein the territory encompasses a non-contiguous geographical region.

23. The non-transitory computer-readable medium of claim 17, wherein the territory encompasses a non-contiguous geographical region.
